(19) United States
(12) Patent Application Publication
(10) Pub. No.: US 2025/0354502 A1
(43) Pub. Date: Nov. 20, 2025

(54) ASSEMBLED DIAPHRAGM FOR STEAM TURBINE AND PRODUCTION DEVICE THEREOF

(71) Applicant: HUANENG SHANTOU HAIMEN POWER GENERATION CO., LTD., Shantou (CN)

(72) Inventors: Feng Zhang, Shantou (CN); Hongjin Li, Shantou (CN); Liang You, Shantou (CN); Chuangwei Zheng, Shantou (CN); Bao'e Yang, Shantou (CN); Xingguo Jiang, Shantou (CN); Yu Chen, Shantou (CN); Peng Wang, Shantou (CN); Quan Zhou, Shantou (CN); Xudian Lu, Shantou (CN); Zhifeng Shui, Shantou (CN); Xuejian Hong, Shantou (CN)

(73) Assignee: HUANENG SHANTOU HAIMEN POWER GENERATION CO., LTD., Shantou (CN)

(21) Appl. No.: 19/230,018

(22) Filed: Jun. 5, 2025

(30) Foreign Application Priority Data
Jun. 26, 2024 (CN) 202410842236.3

(51) Int. Cl. F01D 25/24; G08B 21/18

(52) U.S. Cl. CPC F01D 25/24; G08B 21/182

(57) ABSTRACT

An assembled diaphragm for steam turbine and a production device thereof are provided, which relate to the technical field of steam turbine manufacturing. The diaphragm includes diaphragm inner rings and diaphragm outer rings, the diaphragm inner rings and the diaphragm outer rings are semicircular, and blades are arranged between the diaphragm inner rings and the diaphragm outer rings, two the diaphragm inner rings are symmetrically connected through a connecting assembly, and two the diaphragm outer rings are symmetrically connected through multiple connecting assemblies. Two semicircular diaphragm inner rings are connected into a complete circular diaphragm inner ring through multiple connecting assemblies, and two semicircular diaphragm outer rings are connected into a complete circular diaphragm outer ring through multiple connecting assemblies, and then the blade is welded and fixed between the complete circular diaphragm inner ring and the circular diaphragm outer ring.

### CROSS-REFERENCE TO RELATED APPLICATIONS

This application claims priority of Chinese Patent Application No. 202410842236.3, filed on Jun. 26, 2024, the content of which is hereby incorporated by reference.

### TECHNICAL FIELD

The disclosure relates to the technical field of steam turbine manufacturing, and in particular to an assembled diaphragm for steam turbine and a production device thereof.

### BACKGROUND

A steam turbine, also known as a steam turbine engine, is a rotary steam power device, which can make high-temperature and high-pressure steam pass through a fixed nozzle to become an accelerated airflow and then spray it on the blades, so that the rotor equipped with blade rows can rotate, and the thermal energy of the steam can be converted into mechanical energy for the rotation of the steam turbine rotor, thereby doing external work. Steam turbine is the main equipment of modern thermal power plant, and it is also used in metallurgical industry, chemical industry and ship power device.

The diaphragm in a steam turbine is a disc-shaped component installed in the cylinder of the steam turbine and dividing the cylinder into several chambers with different pressures. Its main function is to install nozzles or stationary blades and prevent steam leakage between stages. When the steam working medium flows through the nozzles installed on the diaphragm, potential energy is converted into kinetic energy, the pressure is decreased, the speed is increased, and then the moving blades is entered to do work. The diaphragm is installed in the groove on the inner wall of the cylinder and is generally divided into upper and lower halves, which straddle the rotating shaft, and the rotating shaft passes through its center. Usually, the diaphragm is circular, which takes too long and is inefficient when it is installed in the designated position in the cylinder.

### SUMMARY

An assembled diaphragm for a steam turbine and a production device thereof are provided, which are used for solving the defects in the prior art.

An assembled diaphragm for a steam turbine and a production device thereof is provided, the diaphragm includes diaphragm inner rings and diaphragm outer rings, the diaphragm inner rings and the diaphragm outer rings are semicircular, and blades are arranged between the diaphragm inner rings and the diaphragm outer rings, two the diaphragm inner rings are symmetrically connected through a connecting assembly, and two the diaphragm outer rings are symmetrically connected through multiple connecting assemblies.

Preferably, the connecting assembly includes connecting grooves, and connecting ends of the diaphragm inner rings and the diaphragm outer rings are respectively provided with the connecting grooves, and mounting posts are arranged in the two connecting grooves, mounting blocks are respectively inserted in the two connecting grooves, left and right ends of the mounting posts are inserted on the two mounting blocks, buffer pads are arranged between two ends of each of the mounting blocks and inner walls of the two connecting grooves; a through groove is vertically arranged at a top of each of the connecting grooves; a connecting rod is inserted into the through groove; and the connecting rod vertically passes through the mounting posts and the mounting blocks and is fixed with top and bottom of each of the connecting grooves.

A production device of assembled diaphragm for steam turbine is provided, which is applied to the assembled diaphragm for the steam turbine and includes an assembly table, a rotating assembly is arranged at a bottom of the assembly table, and a fastening assembly is arranged at a top of the assembly table; the diaphragm inner rings and the diaphragm outer rings are respectively arranged on the assembly table, and the fastening assembly is arranged at inner and outer sides of the diaphragm inner rings and the diaphragm outer rings.

Preferably, the fastening assembly includes limiting pipes an first air rods, where multiple first air rods are arranged on an edge of the assembly table, and multiple limiting pipes are slidably arranged on the assembly table, and an output end of each of the first air rods is connected with one side, facing an outside of the assembly table, of each of the limiting pipes, the limiting pipes are hollow, each of the limiting pipes is provided with a sliding opening, and a clamping plate is arranged between every two limiting pipes, two ends of the clamping plate are respectively inserted into the sliding opening, each of the limiting pipes is threadedly connected with a rotating column, a bottom of the rotating column abuts against a top of the clamping plate, and a bottom surface and a side surface of the clamping plate are respectively provided with chutes, a limiting column is slidably arranged on a chute on the bottom surface of the clamping plate; a fixed valve is slidably arranged on a chute on the side surface of the clamping plate; the fixed valve is threadedly connected with a top of the limiting column; the fixed valve is provided with a rotating handle.

Preferably, the rotating assembly includes a base, the base is provided with a first motor and a pipe rack, and the first motor is connected with a reducer through a coupling, and an output end of the reducer is provided with a first bevel gear, the pipe rack is rotatably provided with a first rotating shaft, and both ends of the first rotating shaft are respectively provided with a second bevel gear and a third bevel gear, and the first bevel gear meshes with the second bevel gear for transmission, a first supporting frame and a second supporting frame are arranged on the base, a second rotating shaft is rotatably arranged on the first supporting frame, a transmission gear and a fourth bevel gear are arranged on the second rotating shaft, the third bevel gear is meshed with the fourth bevel gear for transmission; the second supporting frame is rotatably provided with a transmission half tooth; an assembly seat is arranged on the transmission half tooth; and the assembly seat is provided with the assembly table.

Preferably, a clamping device is further included, where the clamping device is arranged at one side of the rotating assembly, and the clamping device includes a slide rail, one end of the slide rail is horizontally and fixedly provided with an second air rod, and a lifting seat is slidably arranged on the slide rail, and a top of the lifting seat is provided with a second motor, a screw rod is vertically rotatably arranged in the lifting seat, a top of the screw rod is in transmission with the second motor, and a moving block is threadedly connected with the screw rod, and one side of the moving block is provided with a bearing block, and a third motor is arranged in the bearing block, an output end of the third motor is fixedly connected with one end of a rotating plate, and an insertion cavity and a scaling cavity are opened in a moving frame, front and rear ends of the insertion cavity are penetrated, an other end of the rotating plate is inserted into the insertion cavity, a third rotating shaft is vertically rotatably arranged in the sealing cavity, a spur gear is arranged in a middle of the third rotating shaft, and a side, facing the spur gear, of the rotating plate is provided with teeth, and the spur gear meshes with the teeth on the rotating plate; a top of the moving frame is provided with a fourth motor, and an output end of the fourth motor is in transmission connected with the third rotating shaft, a left side of the moving frame is provided with a clamping head assembly;

Preferably, the clamping head assembly includes a fixed frame, the fixed frame is arranged at one side of the moving frame, a five motor is arranged in the fixed frame, and an output end of the five motor is provided with a rotating frame, the rotating frame is internally provided with a double-shaft motor, two shafts of the double-shaft motor are respectively provided with threads with opposite textures, and two shafts of the double-shaft motor are respectively provided with displacement blocks, and a storage battery is arranged in each of the displacement blocks, one side of the fixed frame is provided with a moving groove, one side, facing the moving groove, of each of the displacement block is provided with a clamping frame, and an electromagnet and a movable cavity are arranged in the clamping frame, the electromagnet is electrically connected with the storage battery, movable columns is inserted into the movable cavity, ends, in the movable cavity, of the movable columns are provided with a magnet block, and an other end of each of the movable columns is provided with a clamping block.

Preferably, the production device further includes:
a first angle measuring module, used for measuring an included angle between two clamped surfaces of a blade during clamping;
a second angle measuring module, used for measuring an included angle between the clamping block and gravity direction during clamping;
a third angle measuring module, used for measuring an included angle between the clamping block and a blade contact surface during clamping;
a distance detection module, used for measuring distance between the electromagnet and the magnet block;
a current intensity detection module, used for detecting real-time current intensity of line in the electromagnet in real time;
an alarm module, used for giving an alarm;
a first calculation module, used for calculating total clamping force required when clamping the blade based on the first angle measuring module, the second angle measuring module the third angle measuring module, and blade weight;
a second calculation module, used for calculating minimum current intensity required for providing the total clamping force based on the total clamping force required for clamping the blade calculated by the first calculation module, a turn number of coils in the electromagnet, effective lengths of the coils and a distance between the electromagnet and the magnet block;
a processing module, used for comparing the minimum current intensity obtained by the second calculation module with a result of the current intensity detection module; and
a control module, used for controlling the clamping device to move still and controlling the alarm module to give an alarm when the current intensity detection module is less than the minimum current intensity.

### BRIEF DESCRIPTION OF THE DRAWINGS

In order to explain the technical scheme of the disclosure or the prior art more clearly, the drawings needed to be used in the description of the embodiments or the prior art will be briefly introduced below. Obviously, the drawings in the following description are some embodiments of the disclosure, and other drawings can be obtained according to these drawings without creative efforts for ordinary skilled in the field.

FIG. 1 is a schematic diagram of the overall structure of an assembled diaphragm for a steam turbine according to an embodiment of the disclosure;

FIG. 2 is a structural schematic diagram of a connecting assembly according to an embodiment of the disclosure;

FIG. 3 is a schematic diagram of the overall structure of an assembled diaphragm production device for a steam turbine according to an embodiment of the disclosure;

FIG. 4 is a schematic diagram of a top sectional structure of a production device of the assembled diaphragm for steam turbine according to an embodiment of the disclosure;

FIG. 5 is a schematic diagram of the overall structure of a production device and a clamping device for the assembled diaphragm for steam turbine according to an embodiment of the disclosure;

FIG. 6 is a schematic sectional diagram of a clamping device according to an embodiment of the disclosure; and

FIG. 7 is a structural schematic diagram of a clamping head assembly according to an embodiment of the disclosure.

List of reference characters: 1 diaphragm inner ring; 2 diaphragm outer ring; 3 blade; 4 connecting assembly; 41 connecting groove; 42 mounting post; 43 mounting block; 44 buffer pad; 45 through groove; 46 connecting rod; 5 assembly table; 6 fastening assembly; 61 limiting pipe; 611 sliding opening; 62 first air rod; 63 clamping plate; 64 rotating column; 65 chute; 66 limiting column; 67 fixed valve; 68 rotating handle; 7 rotating assembly; 71 base; 72 first motor; 73 pipe rack; 74 reducer; 75 first bevel gear; 76 first rotating shaft; 77 second bevel gear; 78 third bevel gear; 79 first supporting frame; 80 second supporting frame; 81 second rotating shaft; 82 transmission gear; 83 fourth bevel gear; 84 transmission half tooth; 85 assembly seat; 9 clamping device; 91 slide rail; 92 second air rod; 93 lifting seat; 94 second motor; 95 screw rod; 96 moving block; 97 bearing block; 98 third motor; 99 rotating plate; 100 moving frame; 101 sealing cavity; 102 insertion cavity; 103 third rotating shaft; 104 spur gear; 105 fourth motor; 106 clamping head assembly; 1061 fixed frame; 1062 five motor; 1063 rotating frame; 1064 double-shaft motor; 1065 displacement block; 1066 storage battery; 1067 moving groove; 1068 clamping frame; 1069 electromagnet; 1070 movable cavity; 1071 movable column; 1072 magnet block; and 1073 clamping block.

### DETAILED DESCRIPTION OF THE EMBODIMENTS

In order to make the purpose, technical scheme and advantages of the disclosure more clear, the technical scheme in the disclosure will be described clearly and completely with reference to the attached drawings. Obviously, the described embodiments are a part of the embodiments of the disclosure, but not all of the embodiments. Based on the embodiments in the disclosure, all other embodiments obtained by ordinary skilled in the field without creative efforts belong to the scope of protection of the disclosure.

In addition, in the disclosure, descriptions such as “first” and “second” are only used for description purposes, and do not specifically refer to the order or sequence, nor are they used to limit the disclosure. They are only used to distinguish assemblies or operations described in the same technical terms, and cannot be understood as indicating or implying their relative importance or implicitly indicating the number of indicated technical features. Therefore, the features defined as “first” and “second” can explicitly or implicitly include at least one of these features. In addition, the technical solutions and technical features of each embodiment can be combined with each other, but they must be based on the realization of ordinary skilled in the field. When the combination of technical solutions is contradictory or impossible, it should be considered that the combination of technical solutions does not exist and is not within the scope of protection claimed by the disclosure.

The following embodiments are provided.

### Embodiment 1

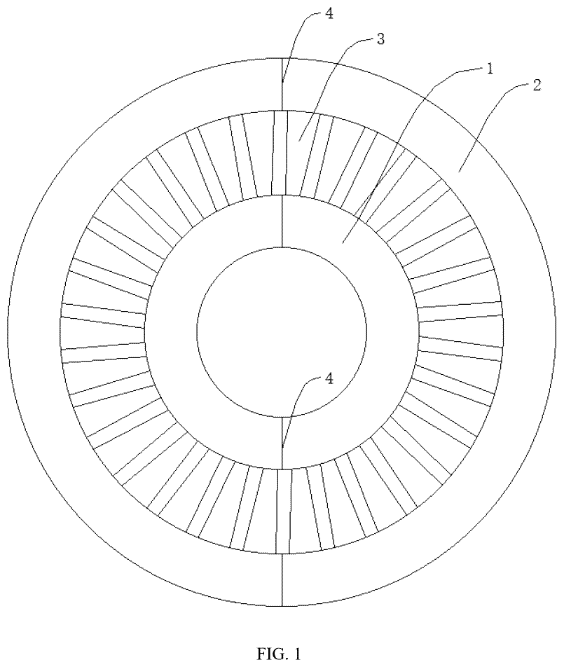

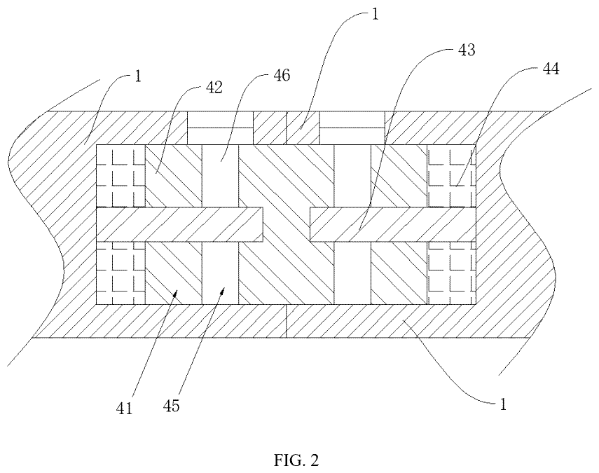

The embodiment of the disclosure provides an assembled diaphragm for a steam turbine, as shown in FIGS. 1 and 2, including diaphragm inner rings 1 and diaphragm outer rings 2, the diaphragm inner rings 1 and the diaphragm outer rings 2 are semicircular, and blades 3 are arranged between the diaphragm inner rings 1 and the diaphragm outer rings 2, two the diaphragm inner rings 1 are symmetrically connected through a connecting assembly 4, and two the diaphragm outer rings 2 are symmetrically connected through multiple connecting assemblies 4.

The working principle and beneficial effects of the above technical scheme are as follows: two semicircular diaphragm inner rings 1 are connected into a complete circular diaphragm inner ring 1 through multiple connecting assemblies 4, and two semicircular diaphragm outer rings 2 are connected into a complete circular diaphragm outer ring 2 through multiple connecting assemblies 4, and then the blade 3 is welded and fixed between the complete circular diaphragm inner ring 1 and the circular diaphragm outer ring 2, which facilitates the disassembly and assembly of the circular diaphragm inner ring 1 and the circular diaphragm outer ring 2 in the steam turbine cylinder, the installation and disassembly time of the diaphragm in the cylinder is shortened, and the time cost in production is reduced.

### Embodiment 2

On the basis of Embodiment 1, as shown in FIGS. 1 and 2, the connecting assembly 4 includes connecting grooves 41, and connecting ends of the diaphragm inner rings 1 and the diaphragm outer rings 2 are respectively provided with the connecting grooves 41, and mounting posts 42 are arranged in the two connecting grooves 41, mounting blocks 43 are respectively inserted in the two connecting grooves 41, left and right ends of the mounting posts 42 are inserted on the two mounting blocks 43, buffer pads 44 are arranged between two ends of each of the mounting blocks 43 and inner walls of the two connecting grooves 41; a through groove 45 is vertically arranged at a top of each of the connecting grooves 41; a connecting rod 46 is inserted into the through groove 45; and the connecting rod 46 vertically passes through the mounting posts 42 and the mounting blocks 43 and is fixed with top and bottom of each of the connecting grooves 41.

The working principle and beneficial effects of the above technical scheme are as follows: connecting grooves 41 are formed between the semicircular diaphragm inner ring 1 and the semicircular diaphragm inner ring 1, mounting posts 42 are fixedly arranged in the two connecting grooves 41, and the two connecting grooves 41 are merged, and mounting blocks 43 are placed in the mounting grooves, and the mounting posts 42 in the two connecting grooves 41 are inserted into both ends of the mounting blocks 43, so that the connection strength between the two semicircular diaphragm inner rings 1 is enhanced. Buffer pads 44 arranged between the two ends of the mounting block 43 and the inner walls of the two connecting grooves 41 alleviate the stress generated when the two semicircular diaphragm inner rings 1 are squeezed to the middle. The through grooves 45 vertically penetrate the mounting block 43 and the mounting post 42 and insert to connecting rod 46, so that the connecting rod 46 locks and strengthens the connection between the mounting block 43 and the mounting post 42 from other directions, further enhancing the connection strength between the two semicircular diaphragm inner rings 1. The principle of strengthening the connection strength between the two semicircular diaphragm outer rings 2 by the connecting assembly 4 is the same as above.

### Embodiment 3

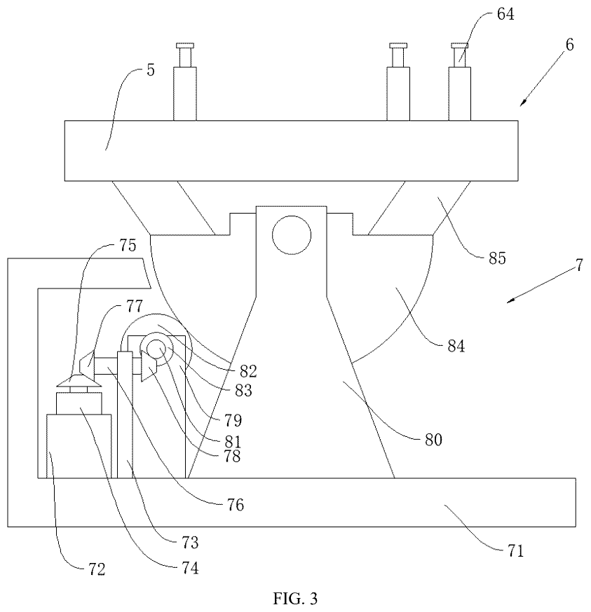

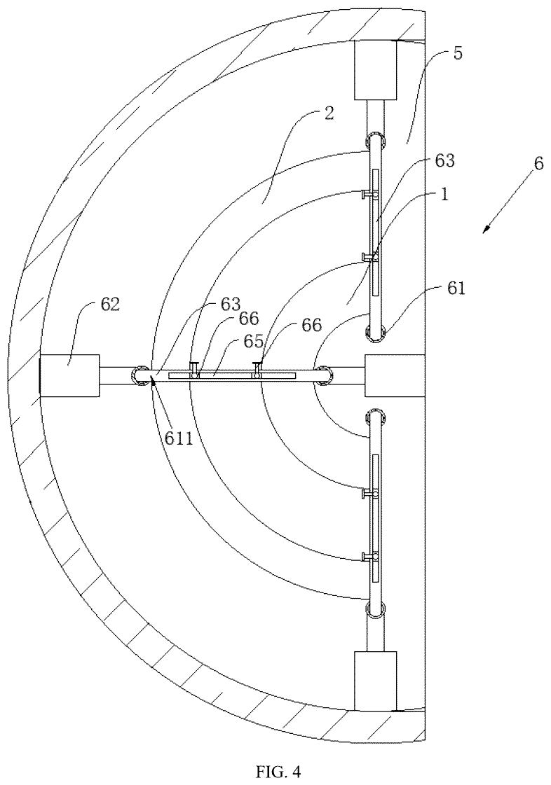

On the basis of Embodiments 1-2, a production device of assembled diaphragm for steam turbine is applied to the above-mentioned assembled diaphragm for steam turbine, as shown in FIGS. 3 and 4, includes an assembly table 5, a rotating assembly 7 is arranged at a bottom of the assembly table 5, and a fastening assembly 6 is arranged at a top of the assembly table 5; the diaphragm inner rings 1 and the diaphragm outer rings 2 are respectively arranged on the assembly table 5, and the fastening assembly 6 is arranged at inner and outer sides of the diaphragm inner rings 1 and the diaphragm outer rings 2.

The working principle and beneficial effects of the above technical scheme are as follows: the rotating assembly 7 supports and adjusts the angle of the assembly table 5, and the assembly table 5 supports and fixes the diaphragm inner ring 1, the diaphragm outer ring 2 and the fastening assembly 6. The blades 3 are welded between the diaphragm inner ring 1 and the diaphragm outer ring 2 under the condition that the diaphragm inner ring 1 and the diaphragm outer ring 2 are fixed by the fastening assembly 6, so as to prevent the welding effect from being affected due to the looseness of the diaphragm inner ring 1 and the diaphragm outer ring 2 in the welding process.

### Embodiment 4

On the basis of Embodiment 3, as shown in FIGS. 3 and 4, the fastening assembly 6 includes limiting pipes 61 an first air rods 62, where multiple first air rods 62 are arranged on an edge of the assembly table 5, and multiple limiting pipes 61 are slidably arranged on the assembly table 5, and an output end of each of the first air rods 62 is connected with one side, facing an outside of the assembly table 5, of each of the limiting pipes 61, the limiting pipes 61 are hollow, each of the limiting pipes 61 is provided with a sliding opening 611, and a clamping plate 63 is arranged between every two limiting pipes 61, two ends of the clamping plate 63 are respectively inserted into the sliding opening 611, each of the limiting pipes 61 is threadedly connected with a rotating column 64, a bottom of the rotating column 64 abuts against a top of the clamping plate 63, and a bottom surface and a side surface of the clamping plate 63 are respectively provided with chutes 65, a limiting column 66 is slidably arranged on a chute 65 on the bottom surface of the clamping plate 63; a fixed valve 67 is slidably arranged on a chute 65 on the side surface of the clamping plate 63; the fixed valve 67 is threadedly connected with a top of the limiting column 66; the fixed valve 67 is provided with a rotating handle 68.

The working principle and beneficial effects of the above technical scheme are as follows: the first air rod 62 pushes the limiting pipe 61 to move on the slide rail 91 opened on the assembly table 5, and the limiting pipe 61 squeezes the inner edge of the diaphragm inner ring 1 and the outer edge of the diaphragm outer ring 2 placed on the assembly table 5. A clamping plate 63 is arranged between every two limiting pipes 61, and the clamping plate 63 presses the diaphragm inner ring 1 and the diaphragm outer ring 2 on the assembly table 5 for fastening. The two ends of the clamping plate 63 are inserted into the the rotating column 64 in the limiting pipe 61 from the sliding opening 611, the rotating column 64 is rotated below the limiting pipe 61. When the bottom of the rotating column 64 abuts against the top of the clamping plate 63, the two ends of the clamping plate 63 are clamped by the two rotating columns 64, and the clamping plate 63 locks the diaphragm inner ring 1 and the diaphragm outer ring 2 on the assembly table 5. A limiting column 66 and a fixed valve 67 are slidably arranged in two chutes 65 formed on the clamping plate 63. The limiting column 66 squeezes the outer edge of the diaphragm inner ring 1 and the inner edge of the diaphragm outer ring 2 to further limit and fix the position between the diaphragm inner ring 1 and the diaphragm outer ring 2. The fixed valve 67 is connected with the top of the limiting column 66 through threads, and the fixed valve 67 rotates by rotating the rotating handle 68. The fixed valve 67 penetrates into the top depth of the limiting column 66 through the thread. When the rotating handle 68 abuts against the side surface of the clamping plate 63, the fixed valve 67 cannot move in the chute 65 of the clamping plate 63. At this time, the limiting column 66 is locked and fails to move. The position of the diaphragm inner ring 1 and the diaphragm outer ring 2 is further locked by the limiting column 66 of being locked and failing to move, which ensures the stability of the diaphragm inner ring 1 and the diaphragm outer ring 2 during welding.

### Embodiment 5

On the basis of Embodiment 4, as shown in FIG. 3, the rotating assembly 7 includes a base 71, the base 71 is provided with a first motor 72 and a pipe rack 73, and the first motor 72 is connected with a reducer 74 through a coupling, and an output end of the reducer 74 is provided with a first bevel gear 75, the pipe rack 73 is rotatably provided with a first rotating shaft 76, and both ends of the first rotating shaft 76 are respectively provided with a second bevel gear 77 and a third bevel gear 78, and the first bevel gear 75 meshes with the second bevel gear 77 for transmission, a first supporting frame 79 and a second supporting frame 80 are arranged on the base 71, a second rotating shaft 81 is rotatably arranged on the first supporting frame 79, a transmission gear 82 and a fourth bevel gear 83 are arranged on the second rotating shaft 81, the third bevel gear 78 is meshed with the fourth bevel gear 83 for transmission; the second supporting frame 80 is rotatably provided with a transmission half tooth 84; an assembly seat 85 is arranged on the transmission half tooth 84; and the assembly seat 85 is provided with the assembly table 5.

The working principle and beneficial effects of the above technical scheme are as follows: the base 71 supports and limits the first motor 72, the pipe rack 73, the first supporting frame 79 and the second supporting frame 80, the first motor 72 drives the reducer 74 to work through the coupling, the output end of the reducer 74 drives the first bevel gear 75 to rotate, and the pipe rack 73 rotatably supports the first rotating shaft 76. The first bevel gear 75 drives the first rotating shaft 76 and the third bevel gear 78 to rotate through the meshing with the second bevel gear 77. The third bevel gear 78 drives the second rotating shaft 81 and the transmission gear 82 to rotate on the first supporting frame 79 through the meshing with the fourth bevel gear 83; and the transmission gear 82 drives the transmission half tooth 84, the assembly seat 85 and the assembly table 5 to rotate on the second supporting frame 80 through the meshing with the transmission half tooth 84, thereby adjusting the welding angle of the diaphragm inner ring 1 and the diaphragm outer ring 2 on the assembly table 5.

### Embodiment 6

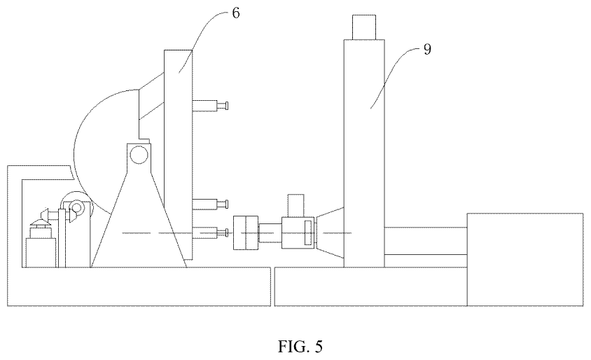

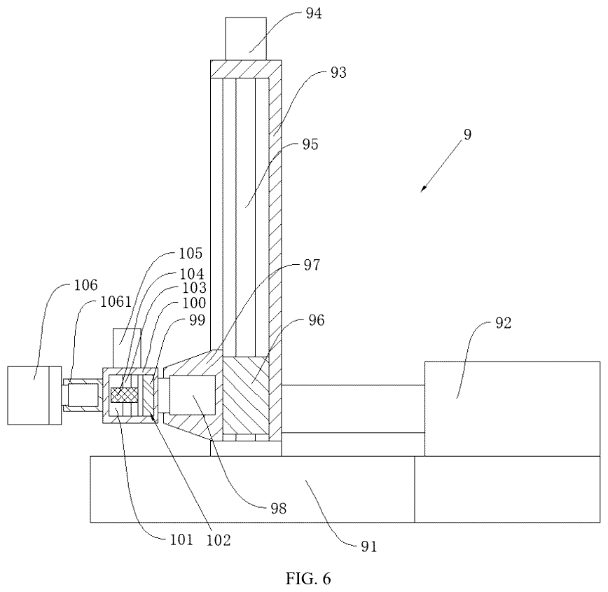

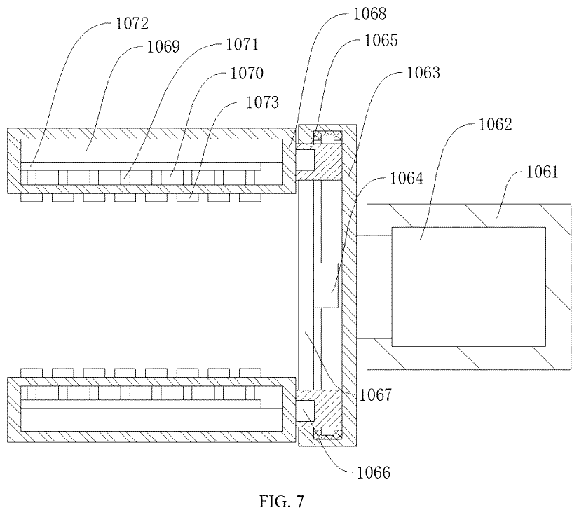

On the basis of Embodiment 5, as shown in FIGS. 5, 6 and 7, the device further includes a clamping device 9. The clamping device 9 is arranged at one side of the rotating assembly 7, and the clamping device 9 includes a slide rail 91, one end of the slide rail 91 is horizontally and fixedly provided with an second air rod 92, and a lifting seat 93 is slidably arranged on the slide rail 91, and a top of the lifting seat 93 is provided with a second motor 94, a screw rod 95 is vertically rotatably arranged in the lifting seat 93, a top of the screw rod 95 is in transmission with the second motor 94, and a moving block 96 is threadedly connected with the screw rod 95, and one side of the moving block 96 is provided with a bearing block 97, and a third motor 98 is arranged in the bearing block 97, an output end of the third motor 98 is fixedly connected with one end of a rotating plate 99, and an insertion cavity 102 and a sealing cavity 101 are opened in a moving frame 100, front and rear ends of the insertion cavity 102 are penetrated, an other end of the rotating plate 99 is inserted into the insertion cavity 102, a third rotating shaft 103 is vertically rotatably arranged in the sealing cavity 101, a spur gear 104 is arranged in a middle of the third rotating shaft 103, and a side, facing the spur gear 104, of the rotating plate 99 is provided with teeth, and the spur gear 104 meshes with the teeth on the rotating plate 99; a top of the moving frame 100 is provided with a fourth motor 105, and an output end of the fourth motor 105 is in transmission connected with the third rotating shaft 103, a left side of the moving frame 100 is provided with a clamping head assembly 106.

The working principle and beneficial effects of the above technical scheme are as follows: after the positions of the diaphragm inner ring 1 and the diaphragm outer ring 2 are adjusted and fixed in place, the clamping device 9 clamps the blade 3 and moves the clamped blade 3 to the welding position between the diaphragm inner ring 1 and the diaphragm outer ring 2, and the second air rod 92 pushes the lifting seat 93 to move on the slide rail 91, so as to adjust the distance between the clamping device 9 and the assembly table 5 and find the best welding position of the blade 3. The second motor 94 drives the screw rod 95 vertically arranged in the lifting seat 93 to rotate, and the screw rod 95 rotates to adjust the height position of the moving block 96 along the direction of the screw rod 95, and the moving block 96 drives the bearing block 97 to move synchronously, and the bearing block 97 limits and fixes the third motor 98, and the third motor 98 drives the rotating plate 99 to rotate around the bearing block 97 with the length of the rotating plate 99 as the radius. The moving frame 100 rotates around the bearing block 97 on the rotating plate 99. The rotating plate 99 is inserted into the insertion cavity 102 of the moving frame 100. The fourth motor 105 drives the third rotating shaft 103 to drive the spur gear 104 to rotate. The spur gear 104 drives the moving frame 100 to move on the rotating plate 99 by meshing with the teeth on the rotating plate 99, thus adjusting the positions of the moving frame 100 and the clamping head assembly 106 on the rotating plate 99. When the assembly table 5 rotates to a vertical position facing the clamping device 9, the center axes of the diaphragm inner ring 1 and the diaphragm outer ring 2 on the assembly table 5 are on the same line with the axis of the bearing block 97, and the radius of the diaphragm inner ring 1 and the diaphragm outer ring 2 corresponds to the length of the moving frame 100 on the rotating plate 99, so that the blade 3 may be flexibly clamped to a proper position by the clamping head assembly 106.

### Embodiment 7

On the basis of Embodiment 6, as shown in FIGS. 5, 6 and 7, the clamping head assembly 106 includes a fixed frame 1061, the fixed frame 1061 is arranged at one side of the moving frame 100, a five motor 1062 is arranged in the fixed frame 1061, and an output end of the five motor 1062 is provided with a rotating frame 1063, the rotating frame 1063 is internally provided with a double-shaft motor 1064, two shafts of the double-shaft motor 1064 are respectively provided with threads with opposite textures, and two shafts of the double-shaft motor 1064 are respectively provided with displacement blocks 1065, and a storage battery 1066 is arranged in each of the displacement blocks 1065, one side of the fixed frame 1061 is provided with a moving groove 1067, one side, facing the moving groove 1067, of each of the displacement block 1065 is provided with a clamping frame 1068, and an electromagnet 1069 and a movable cavity 1070 are arranged in the clamping frame 1068, the electromagnet 1069 is electrically connected with the storage battery 1066, movable columns 1071 is inserted into the movable cavity 1070, ends, in the movable cavity 1070, of the movable columns 1071 are provided with a magnet block 1072, and an other end of each of the movable columns 1071 is provided with a clamping block 1073.

The working principle and beneficial effects of the above technical scheme are as follows: the fixed frame 1061 rotates synchronously with the moving frame 100, the fixed frame 1061 limits and fixes the fifth motor 1062, and the fifth motor 1062 drives the rotating frame 1063 to rotate, thus flexibly adjusting the angle of the clamped blade 3, and the rotating frame 1063 fixes the double-shaft motor 1064. Threads with opposite textures on the shafts at both ends of the double-shaft motor 1064 drive two displacement blocks 1065 on the shafts at both ends to move towards or away from each other, and the two displacement blocks 1065 drive two clamping frames 1068 to move towards or away from each other in the opening movement, thus controlling the distance between the two clamping frames 1068. The electromagnets 1069 in the clamping frames 1068 are magnetic when the storage battery 1066 provides electric energy. The magnetism of the electromagnet 1069 repels multiple magnet blocks 1072 in the movable cavity 1070, and the magnet blocks 1072 drive multiple movable columns 1071 and multiple clamping blocks 1073 to move in the central direction of two clamping frames 1068, and the clamping blocks 1073 in two directions clamp the middle blade 3. The clamping method of multiple clamping blocks 1073 prevents the blade 3 from being deformed due to too concentrated clamping points in the process of clamping the blade 3.

### Embodiment 8

On the basis of Embodiment 7, the device further includes:
a first angle measuring module, used for measuring an included angle between two clamped surfaces of a blade during clamping;
a second angle measuring module, used for measuring an included angle between the clamping block and gravity direction during clamping;
a third angle measuring module, used for measuring an included angle between the clamping block and a blade contact surface during clamping;
a distance detection module, used for measuring distance between the electromagnet and the magnet block;
a current intensity detection module, used for detecting real-time current intensity of line in the electromagnet in real time;
an alarm module, used for giving an alarm;
a first calculation module, used for calculating total clamping force required when clamping the blade based on the first angle measuring module, the second angle measuring module the third angle measuring module, and blade weight;
a second calculation module, used for calculating minimum current intensity required for providing the total clamping force based on the total clamping force required for clamping the blade calculated by the first calculation module, a turn number of coils in the electromagnet, effective lengths of the coils and a distance between the electromagnet and the magnet block;
a processing module, used for comparing the minimum current intensity obtained by the second calculation module with a result of the current intensity detection module; and
a control module, used for controlling the clamping device to move still and controlling the alarm module to give an alarm when the current intensity detection module is less than the minimum current intensity.

The working principle and beneficial effects of the technical scheme are as follows: the first angle measuring module is used for measuring an included angle between two clamped surfaces of a blade during clamping; the second angle measuring module is used for measuring an included angle between the clamping block and gravity direction during clamping; the third angle measuring module is used for measuring an included angle between the clamping block and a blade contact surface during clamping; the distance detection module is used for measuring distance between the electromagnet and the magnet block; the current intensity detection module is used for detecting real-time current intensity of line in the electromagnet in real time; the alarm module is used for giving an alarm; the first calculation module is used for calculating total clamping force required when clamping the blade based on the first angle measuring module, the second angle measuring module the third angle measuring module, and blade weight; the second calculation module is used for calculating minimum current intensity required for providing the total clamping force based on the total clamping force required for clamping the blade calculated by the first calculation module, a turn number of coils in the electromagnet, effective lengths of the coils and a distance between the electromagnet and the magnet block; the processing module is used for comparing the minimum current intensity obtained by the second calculation module with a result of the current intensity detection module; and the control module is used for controlling the clamping device to move still and controlling the alarm module to give an alarm when the current intensity detection module is less than the minimum current intensity.

What is claimed is:

1. A production device of assembled diaphragm for steam turbine, used for producing an assembled diaphragm for steam turbine, wherein the diaphragm comprises diaphragm inner rings and diaphragm outer rings, the diaphragm inner rings and the diaphragm outer rings are semicircular, and blades are arranged between the diaphragm inner rings and the diaphragm outer rings, two the diaphragm inner rings are symmetrically connected through a connecting assembly, and two the diaphragm outer rings are symmetrically connected through a plurality of connecting assemblies;
a production device comprises an assembly table, wherein a rotating assembly is arranged at a bottom of the assembly table, and a fastening assembly is arranged at a top of the assembly table; the diaphragm inner rings and the diaphragm outer rings are respectively arranged on the assembly table, and the fastening assembly is arranged at inner and outer sides of the diaphragm inner rings and the diaphragm outer rings;
the fastening assembly comprises limiting pipes an first air rods, wherein the plurality of first air rods are arranged on an edge of the assembly table, and the plurality of limiting pipes are slidably arranged on the assembly table, and an output end of each of the first air rods is connected with one side, facing an outside of the assembly table, of each of the limiting pipes, the limiting pipes are hollow, each of the limiting pipes is provided with a sliding opening, and a clamping plate is arranged between every two limiting pipes, two ends of the clamping plate are respectively inserted into the sliding opening, each of the limiting pipes is threadedly connected with a rotating column, a bottom of the rotating column abuts against a top of the clamping plate, and a bottom surface and a side surface of the clamping plate are respectively provided with chutes, a limiting column is slidably arranged on a chute on the bottom surface of the clamping plate; a fixed valve is slidably arranged on a chute on the side surface of the clamping plate; the fixed valve is threadedly connected with a top of the limiting column; the fixed valve is provided with a rotating handle;
further comprises a clamping device, wherein the clamping device is arranged at one side of the rotating assembly, and the clamping device comprises a slide rail, one end of the slide rail is horizontally and fixedly provided with an second air rod, and a lifting seat is slidably arranged on the slide rail, and a top of the lifting seat is provided with a second motor, a screw rod is vertically rotatably arranged in the lifting seat, a top of the screw rod is in transmission with the second motor, and a moving block is threadedly connected with the screw rod, and one side of the moving block is provided with a bearing block, and a third motor is arranged in the bearing block, an output end of the third motor is fixedly connected with one end of a rotating plate, and an insertion cavity and a sealing cavity are opened in a moving frame, front and rear ends of the insertion cavity are penetrated, an other end of the rotating plate is inserted into the insertion cavity, a third rotating shaft is vertically rotatably arranged in the sealing cavity, a spur gear is arranged in a middle of the third rotating shaft, and a side, facing the spur gear, of the rotating plate is provided with teeth, and the spur gear meshes with the teeth on the rotating plate; a top of the moving frame is provided with a fourth motor, and an output end of the fourth motor is in transmission connected with the third rotating shaft, a left side of the moving frame is provided with a clamping head assembly;
the clamping head assembly comprises a fixed frame, the fixed frame is arranged at one side of the moving frame, a five motor is arranged in the fixed frame, and an output end of the five motor is provided with a rotating frame, the rotating frame is internally provided with a double-shaft motor, two shafts of the double-shaft motor are respectively provided with threads with opposite textures, and two shafts of the double-shaft motor are respectively provided with displacement blocks, and a storage battery is arranged in each of the displacement blocks, one side of the fixed frame is provided with a moving groove, one side, facing the moving groove, of each of the displacement block is provided with a clamping frame, and an electromagnet and a movable cavity are arranged in the clamping frame, the electromagnet is electrically connected with the storage battery, movable columns is inserted into the movable cavity, ends, in the movable cavity, of the movable columns are provided with a magnet block, and an other end of each of the movable columns is provided with a clamping block;
further comprising:
a first angle measuring module, used for measuring an included angle between two clamped surfaces of a blade during clamping;
a second angle measuring module, used for measuring an included angle between the clamping block and gravity direction during clamping;
a third angle measuring module, used for measuring an included angle between the clamping block and a blade contact surface during clamping;
a distance detection module, used for measuring distance between the electromagnet and the magnet block;
a current intensity detection module, used for detecting real-time current intensity of line in the electromagnet in real time;
an alarm module, used for giving an alarm;
a first calculation module, used for calculating total clamping force required when clamping the blade based on the first angle measuring module, the second angle measuring module the third angle measuring module, and blade weight;
a second calculation module, used for calculating minimum current intensity required for providing the total clamping force based on the total clamping force required for clamping the blade calculated by the first calculation module, a turn number of coils in the electromagnet, effective lengths of the coils and a distance between the electromagnet and the magnet block;
a processing module, used for comparing the minimum current intensity obtained by the second calculation module with a result of the current intensity detection module; and
a control module, used for controlling the clamping device to move still and controlling the alarm module to give an alarm when the current intensity detection module is less than the minimum current intensity.

2. The production device of assembled diaphragm for steam turbine according to claim 1, wherein the connecting assembly comprises connecting grooves, and connecting ends of the diaphragm inner rings and the diaphragm outer rings are respectively provided with the connecting grooves, and mounting posts are arranged in the two connecting grooves, mounting blocks are respectively inserted in the two connecting grooves, left and right ends of the mounting posts are inserted on the two mounting blocks, buffer pads are arranged between two ends of each of the mounting blocks and inner walls of the two connecting grooves; a through groove is vertically arranged at a top of each of the connecting grooves; a connecting rod is inserted into the through groove; and the connecting rod vertically passes through the mounting posts and the mounting blocks and is fixed with top and bottom of each of the connecting grooves.

3. The production device of assembled diaphragm for steam turbine according to claim 2, wherein the rotating assembly comprises a base, the base is provided with a first motor and a pipe rack, and the first motor is connected with a reducer through a coupling, and an output end of the reducer is provided with a first bevel gear, the pipe rack is rotatably provided with a first rotating shaft, and both ends of the first rotating shaft are respectively provided with a second bevel gear and a third bevel gear, and the first bevel gear meshes with the second bevel gear for transmission, a first supporting frame and a second supporting frame are arranged on the base, a second rotating shaft is rotatably arranged on the first supporting frame, a transmission gear and a fourth bevel gear are arranged on the second rotating shaft, the third bevel gear is meshed with the fourth bevel gear for transmission; the second supporting frame is rotatably provided with a transmission half tooth; an assembly seat is arranged on the transmission half tooth; and the assembly seat is provided with the assembly table.
